(19) United States
(12) Patent Application Publication
(10) Pub. No.: US 2024/0178625 A1
(43) Pub. Date: May 30, 2024

(54) ELECTRONIC COMPONENT UNIT AND WIRE HARNESSES

(71) Applicant: YAZAKI CORPORATION, Tokyo (JP)

(72) Inventor: Ryo Hiramatsu, Makinohara-shi (JP)

(21) Appl. No.: 18/506,114

(22) Filed: Nov. 9, 2023

(30) Foreign Application Priority Data
Nov. 28, 2022 (JP) 2022-188861

(51) Int. Cl. H01R 25/16; B60R 16/02; H01R 13/514; H01R 13/516; H01R 13/631

(52) U.S. Cl. CPC H01R 25/162; B60R 16/0207; H01R 13/514; H01R 13/516; H01R 13/6315; H01R 2201/26

(57) ABSTRACT

An electronic component unit includes: a connection unit that includes a first connection terminal and a first casing; a first electronic unit that includes a second connection terminal and a second casing; a busbar that electrically connects the first connection terminal and the second connection terminal; and an insulating bracket that includes a recessed part where the busbar is placed, a first connection port, and a second connection port. The first connection terminal includes a first protrusion part 11b that protrudes from the first casing, and is electrically connected to the busbar and mounted to the bracket by being inserted into the first connection port. The second connection terminal includes a second protrusion part that protrudes from the second casing, and is electrically connected to the busbar and mounted to the bracket by being inserted into the second connection port.

### CROSS-REFERENCE TO RELATED APPLICATION (S)

The present application claims priority to and incorporates by reference the entire contents of Japanese Patent Application No. 2022-188861 filed in Japan on Nov. 28, 2022.

### BACKGROUND OF THE INVENTION

### 1. Field of the Invention

The present invention relates to an electronic component unit and a wire harness.

### 2. Description of the Related Art

As a conventional technology related to electronic component units, for example, Japanese Patent Application Laid-open No. H10-012292 discloses a control unit that includes a connection unit having a connection terminal provided at the terminal of a conductive wiring material, and a unit main body having a busbar electrically connected to the connection terminal.

By the way, there is room for further improvement in an electronic component unit disclosed in Japanese Patent Application Laid-open No. H10-012292 described above in terms of improving workability of connection work between units such as the connection units, for example.

### SUMMARY OF THE INVENTION

The present invention is designed in view of the aforementioned circumstances, and it is an object thereof to provide an electronic component unit and a wire harness capable of further improving workability of connection work.

In order to achieve the above mentioned object, an electronic component unit according to one aspect of the present invention includes a connection unit that includes a first connection terminal provided at a terminal of a wiring material exhibiting conductivity, and a first casing that houses the first connection terminal; a first electronic unit that includes a second connection terminal connected to a substrate, and a second casing that houses the substrate and the second connection terminal; a busbar that electrically connects the first connection terminal and the second connection terminal; and an insulating bracket that includes a recessed part where the busbar is placed, a first connection port formed at one end part of the recessed part, and a second connection port formed at another end part of the recessed part, wherein the first connection terminal includes a first protrusion part that protrudes from the first casing, the first protrusion part being electrically connected to the busbar and mounted to the bracket by being inserted into the first connection port, and the second connection terminal includes a second protrusion part that protrudes from the second casing, the second protrusion part being electrically connected to the busbar and mounted to the bracket by being inserted into the second connection port.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary plan view of an electronic component unit applied to a wire harness according to an embodiment;

FIG. 2 is an exemplary plan view of the electronic component unit applied to the wire harness according to the embodiment, which illustrates a state where a connection unit, a first electronic unit, and a second electronic unit are removed from a bracket;

FIG. 3 is an exemplary perspective view of the connection unit and the second electronic unit according to the embodiment;

FIG. 4 is an exemplary perspective view of the connection unit and the second electronic unit according to the embodiment, which is viewed from an angle different from that of FIG. 3;

FIG. 5 is an exemplary side view of a first connection terminal of the connection unit according to the embodiment;

FIG. 6 is an exemplary and schematic sectional view of the first electronic unit according to the embodiment;

FIG. 7 is an exemplary sectional view of a first connection port (second connection port) of the bracket according to the embodiment;

FIG. 8 is an exemplary side view (fragmentary sectional view) for describing a mounting method of the connection unit, the first electronic unit, and the second electronic unit of the electronic component unit according to the embodiment;

FIG. 9 is an exemplary sectional view of a first connection port (second connection port) of a bracket of an electronic component unit according to a first modification; and

FIG. 10 is an exemplary sectional view of a first connection port (second connection port) of a bracket of an electronic component unit according to a second modification.

### DETAILED DESCRIPTION OF THE PREFERRED EMBODIMENTS

Hereinafter, an embodiment and modifications according to the present invention will be described in detail with reference to the drawings. Note, however, that the present invention is not limited by the embodiment and modifications. Furthermore, structural components in the following embodiment and modifications include those that can be easily replaced by those skilled in the art, or those that are substantially the same.

Furthermore, the embodiment and modifications disclosed hereinafter include similar structural components. Therefore, in the followings, common reference signs are applied to those similar structural components and duplicated explanations are omitted. In this specification, it is to be noted that ordinal numbers are used only to distinguish components, members, parts, positions, directions, and the like, and do not indicate the order or priority.

### EMBODIMENT

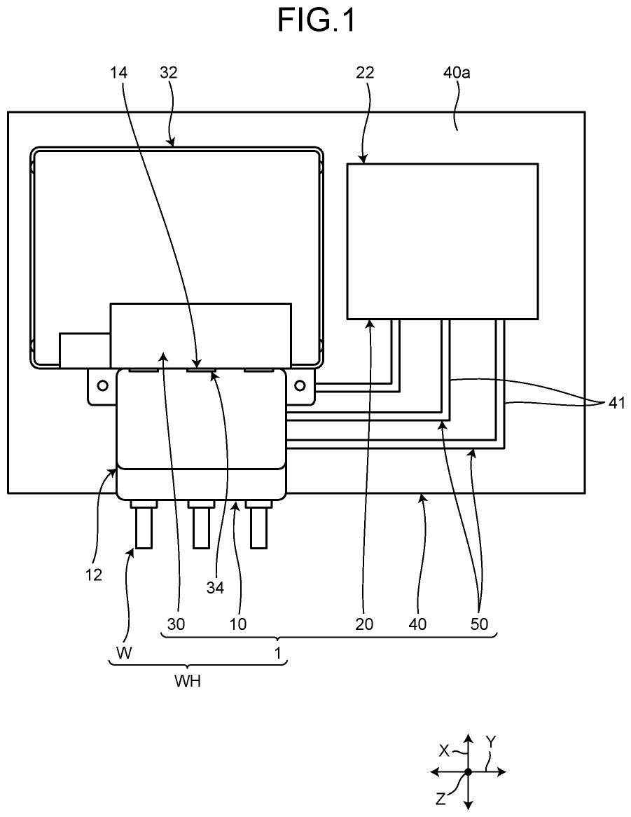

FIG. 1 is a plan view of an electronic component unit 1 applied to a wire harness WH according to an embodiment. The electronic component unit 1 of the present embodiment illustrated in FIG. 1 is mounted into the wire harness WH that is routed in a vehicle such as an automobile. Note here that the wire harness WH is, for example, configured as an aggregate component formed with a bundle of a plurality of wiring materials W used for power supply and signal communication so as to connect the wiring materials W to devices by a connector 14 or the like for connecting each of the devices loaded on a vehicle.

The wire harness WH includes, for example, the conductive wiring materials W and the electronic component unit 1 provided at the terminals of the wiring materials W. The wiring material W is configured including, for example, a conductor part (core wire) formed with a plurality of linear metallic wires twisted together, and an insulating sheath part that covers the outer side of the conductor part. The electronic component unit 1 is configured including, for example, an insulating bracket 40 on which busbars 50 are placed, and a plurality of units such as a connection unit 10, a first electronic unit 20, and a second electronic unit 30 which are mounted onto the bracket 40. In addition, the wire harness WH may further include a protector, a grommet, a fixture, and the like.

In the description hereinafter, in regards to a first direction, a second direction, and a third direction intersecting with each other, the first direction is referred to as an “axial direction X”, the second direction as a “width direction Y”, and the third direction as a “height direction Z”. The axial direction X, the width direction Y, and the height direction Z herein are substantially orthogonal to each other. The axial direction X typically corresponds to an extending direction of the wiring materials W that are inserted into the connection unit 10, an insertion/removal direction of the connector 14 of the connection unit 10 and a mating connector 34 of the second electronic unit 30, and the like. The width direction Y and the height direction Z correspond to intersecting directions that intersect with the axial direction X. Furthermore, unless otherwise noted, each of the directions used in the following description will be described as the direction in a state where the wiring materials W are being mounted to the connection unit 10.

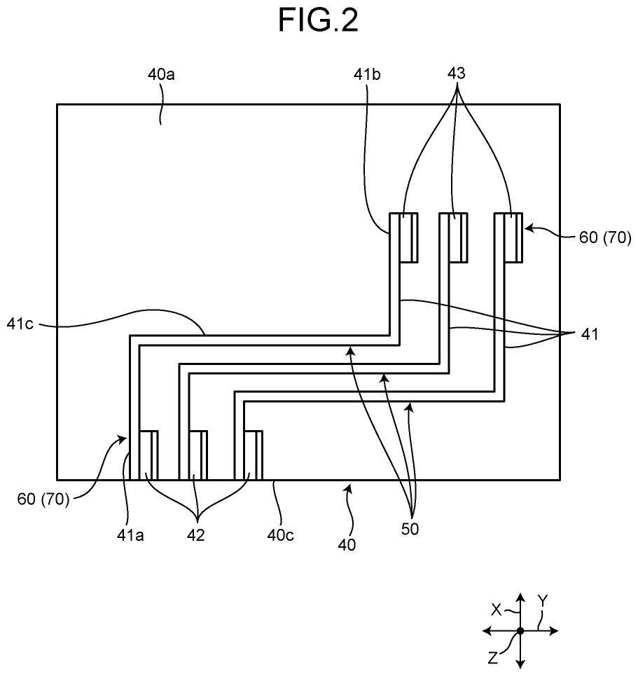

FIG. 2 is a plan view of the electronic component unit 1, which illustrates a state where the connection unit 10, the first electronic unit 20, and the second electronic unit 30 are removed from the bracket 40. As illustrated in FIG. 2, the bracket 40 is a member for securing, for example, the connection unit 10, the first electronic unit 20, the second electronic unit 30, and the like described above to the vehicle side. The bracket 40 as a whole is formed in a shape of a rectangular plate in a size capable of loading the connection unit 10, the first electronic unit 20, and the second electronic unit 30.

A top face 40a on one side of the bracket 40 in the height direction Z has recessed parts 41 in which the busbars 50 are housed and placed. The recessed part 41 is formed to be open toward one side in the height direction z and recessed from the top face 40a toward the other side in the height direction Z. Herein, the recessed part 41 is formed in a crank shape as a whole, which is configured including: one end part 41a positioned on one side in the axial direction X; other end part 41b positioned on the other side in the axial direction X by being shifted from the one end part 41a in the width direction Y; and an intermediate part 41c that is provided between the one end part 41a and the other end part 41b and connects the one end part 41a and the other end part 41b.

Specifically, the one end part 41a extends along the axial direction X from an end face 40c of the bracket 40 on the one side in the axial direction X, the intermediate part 41c extends along the width direction Y from an end part on the other side in the axial direction X of the one end part 41a, and the other end part 41b extends along the axial direction X from one end of the intermediate part 41c on one side in the width direction Y. The busbar 50 is formed in a crank shape along the one end part 41a, the intermediate part 41c, and the other end part 41b of the recessed part 41, and it is inserted and placed along the recessed part 41. In the present embodiment, a plurality of (herein, three) recessed parts 41 and busbars 50 are provided in the bracket 40 by being spaced from each other in the width direction Y and the axial direction X.

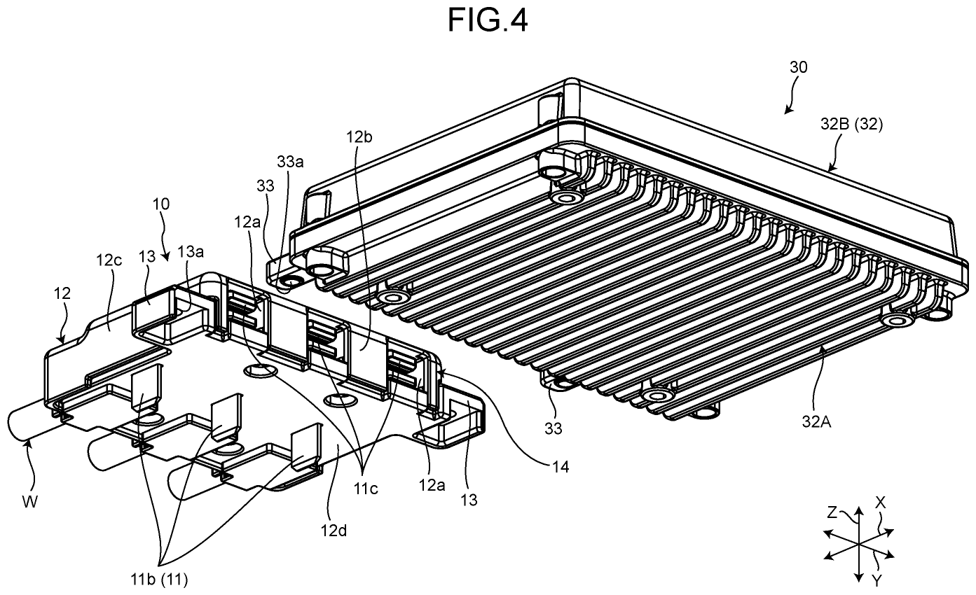

A first connection port 42 is provided at the one end part 41a of the recessed part 41. The first connection port 42 is a part into which a first protrusion part 11b (see FIG. 4) to be described later of the connection unit 10 is inserted. Like the recessed part 41, the first connection port 42 is configured as a recessed part that is open to the one side in the height direction Z and recessed from the top face 40a of the bracket 40 toward the other side in the height direction Z. The first connection port 42 is provided adjacently to the one end part 41a of the recessed part 41 in the width direction Y, and faces one end part of the busbar 50 housed in the recessed part 41. Furthermore, the first connection port 42 is provided to be exposed on the end face 40c of the bracket 40 on the one side in the axial direction X and to be opened along the axial direction X.

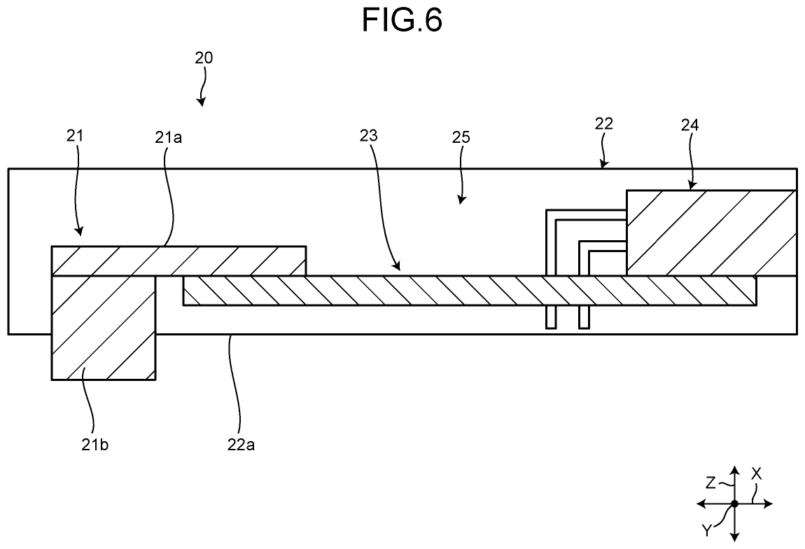

A second connection port 43 is provided at the other end part 41b of the recessed part 41. The second connection port 43 is a part into which a second protrusion part 21b (see FIG. 6) to be described later of the first electronic unit 20 is inserted. Like the recessed part 41 and the first connection port 42, the second connection port 43 is configured as a recessed part that is open to the one side in the height direction Z and recessed from the top face 40a of the bracket 40 toward the other side in the height direction Z. The second connection port 43 is provided adjacently to the other end part 41b of the recessed part 41 in the width direction Y, and faces the other end part of the busbar 50 housed in the recessed part 41.

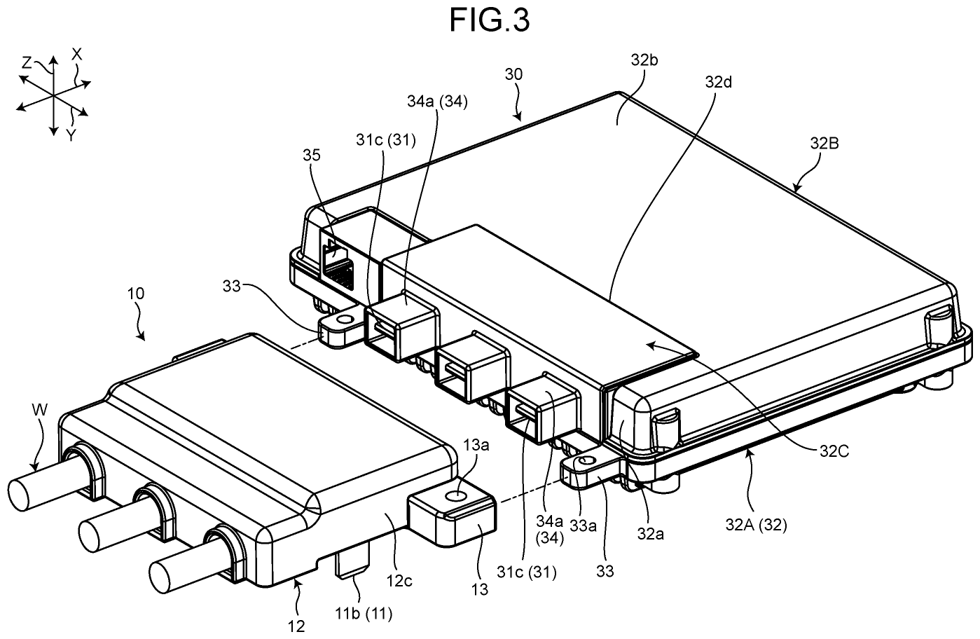

FIG. 3 is a perspective view of the connection unit 10 and the second electronic unit 30 of the electronic component unit 1. As illustrated in FIG. 3, the second electronic unit 30 includes a casing 32 for integrating and housing inside thereof, for example, the mating connector 34 and electrical components such as a DC/DC converter, a DC/AC inverter, a branch part, and a control unit, not illustrated. The second electronic unit 30 is connected between a power source such as a battery and various electronic devices loaded on the vehicle via the wiring materials W and the like, and it is capable of distributing the power supplied from the power source to the various electronic devices in the vehicle. The second electronic unit 30 is also referred to as an electrical junction box, a junction box, or the like.

The casing 32 is configured including, for example, a case 32A, a cover 32B, and a connector housing 32C. The case 32A together with protrusion parts 33 to be described later, for example, is formed with a metal material or the like, and the cover 32B and the connector housing 32C are formed with a resin material or the like. The cover 32B and the connector housing 32C are mounted in a state of being stacked in the height direction Z from the case 32A, and the connector housing 32C is mounted in a state of being in line with the cover 32B in the axial direction X. With such a configuration, the casing 32 is formed in a hollow box shape as a whole with a combination of the case 32A, the cover 32B, and the connector housing 32C. The inner space part of the casing 32 sectioned by the case 32A, the cover 32B, and the connector housing 32C functions as a housing space part.

Specifically, the case 32A is formed as a bottomed cylindrical shape (tray shape) with one side in the height direction Z being opened, and the cover 32B is formed as a bottomed cylindrical shape (tray shape) with the other side in the height direction Z being opened. The peripheral edge of the case 32A and the peripheral edge of the cover 32B are joined by snap-fit or the like. Furthermore, the cover 32B has a notch part 32d provided across a front wall 32a and a top wall 32b on one side in the axial direction X (connection unit 10 side), and the connector housing 32C is mounted to close the notch part 32d. The connector housing 32C is formed, for example, in a shape with a substantially L-shape cross section having a part configuring the front wall 32a and a part configuring the top wall 32b together with the cover 32B, and is opened on the other side in the axial direction X and on both sides of the width direction Y. With such a configuration, the housing space part surrounded by the case 32A, the cover 32B, and the connector housing 32C is formed inside the casing 32.

The mating connector 34 is configured including, for example, a terminal 31 and the connector housing 32C that houses the terminal 31. The terminal 31 is connected to a substrate or the like, not illustrated, which is housed in the housing space part of the casing 32 described above. Herein, the terminal 31 is configured as a male terminal fitting that includes a tab terminal part 31c that is electrically connected to the connector 14 (see FIG. 4) of the connection unit 10 and a substrate connection part that is electrically connected to the substrate. The terminal 31 is configured with a conductive metal as a whole, and each part is integrally formed by press molding a single piece of sheet metal punched into a shape corresponding to each part. In the present embodiment, a plurality of (herein, three) terminals 31 are provided in the mating connector 34 in line in the width direction Y.

The connector housing 32C holds the terminal 31 inside. The connector housing 32C has a fitting part 34a that protrudes from the part configuring the front wall 32a described above toward the one side in the axial direction X (connection unit 10 side). The fitting part 34a is formed in a rectangular tubular shape that covers the surrounding of the tab terminal part 31c of the terminal 31, for example, and is fitted into an opening part 12a on the connector 14 side (see FIG. 4). In the present embodiment, the mating connector 34 has three fitting parts 34a provided in line in the width direction Y correspondingly to the terminals 31. Each of the fitting parts 34a protects the tab terminal part 31c of the respective terminal 31. The connector housing 32C has a connection port 35 that is provided adjacently to the fitting part 34a in the width direction Y, and is capable of connecting to a communication cable such as a LAN cable.

FIG. 4 is a perspective view of the connection unit 10 and the second electronic unit 30 of the electronic component unit 1, which is viewed from an angle different from that of FIG. 3. As illustrated in FIG. 4, the connection unit 10 includes a first casing 12 for integrating and housing inside thereof the connector 14 as well as the terminals of the wiring materials W and the like, for example. The first casing 12 is formed, for example, with a resin material or the like together with pocket parts 13 to be described later. The first casing 12 is formed in a hollow box shape as a whole, and the inner space part sectioned by the outer wall of the first casing 12 functions as the housing space part. The connection unit 10 is also referred to as a connector unit or the like.

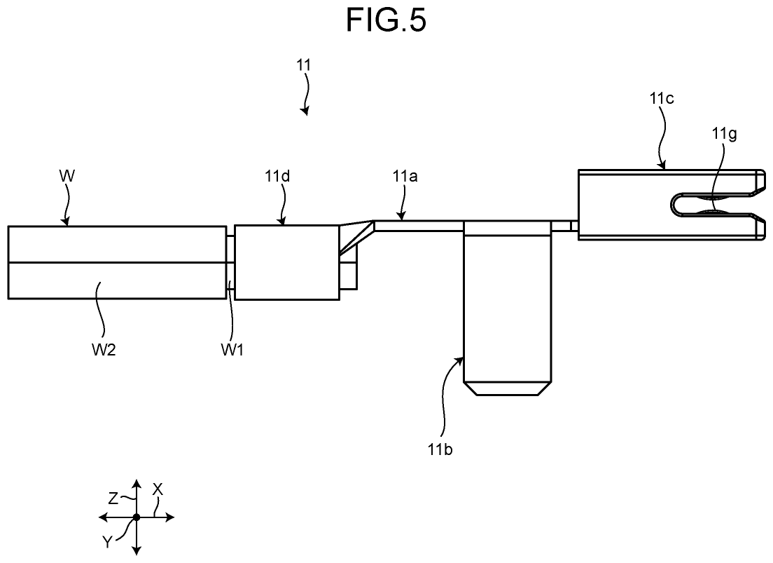

The connector 14 is configured including, for example, a first connection terminal 11 and the first casing 12 as a connector housing that houses the first connection terminal 11. The first connection terminal 11 is connected to the terminal of the wiring material W. Herein, the first connection terminal 11 is configured as a female terminal fitting that includes a connector terminal part 11c as a fork terminal part electrically connected to the tab terminal part 31c of the mating connector 34 described above, and a wire connection part 11d (see FIG. 5) electrically connected to a conductor part W1 exposed on the terminal of the wiring material W. In the present embodiment, the connector 14 has three first connection terminals 11 provided in line in the width direction Y correspondingly to the terminals 31 of the mating connector 34.

The first casing 12 holds inside thereof the first connection terminals 11 and the terminals of the wiring materials W. A front wall 12b of the first casing 12 on the other side (second electronic unit 30 side) of the axial direction X has an opening part 12a into which the fitting part 34a described above is fitted. The opening part 12a is formed in accordance with the external shape of the fitting part 34a as a space part in a size and shape into which the fitting part 34a can be fitted, and it is formed herein to have a substantially rectangular cross-section that is orthogonal to the axial direction X. In the opening part 12a, the connector terminal part 11c of the first connection terminal 11 held in the first casing 12 is provided in a state of being exposed in the axial direction X. In the present embodiment, the connector 14 has three opening parts 12a provided in line in the width direction Y correspondingly to the first connection terminals 11, and the connector terminal parts 11c are protected by the surrounding walls of the opening parts 12a.

Furthermore, the pocket parts 13 are provided on side walls 12c on both sides of the first casing 12 in the width direction Y. The pocket parts 13 are the parts integrally formed with the first casing 12 and into which the protrusion parts 33 on the second electronic unit 30 side are inserted. The pocket parts 13 and the protrusion parts 33 function as positioning parts for aligning the positions of the connector 14 and the mating connector 34. Herein, the pocket parts 13 and the protrusions parts 33 are provided in pairs on both sides of the width direction Y to sandwich the connector 14 and the mating connector 34. The pocket part 13 and the protrusion part 33 have respective through-holes 13a and 33a opened through in the height direction Z, and bolts, not illustrated, are fastened into the through-holes 13a and 33a.

FIG. 5 is a side view of the first connection terminal 11 of the connection unit 10. As illustrated in FIG. 5, the first connection terminal 11 is configured including, for example, the connector terminal part 11c described above, the wire connection part 11d, a coupling part 11a, and the first protrusion part 11b. The first connection terminal 11 is configured with a conductive metal as a whole, and each part is formed integrally by press molding a single piece of sheet metal punched into a shape corresponding to each part. Note that the first connection terminal 11 may have, in the connector terminal part 11c, a contact component 11g as a separate component to reduce contact resistance. In the first connection terminal 11, the connector terminal part 11c, the coupling part 11a, the first protrusion part 11b, and the wire connection part 11d are interconnected in line along the axial direction X from the other side (second electronic unit 30 side) toward the one side.

The connector terminal part 11c is a part (fork terminal part) that is electrically connected to the tab terminal part 31c of the mating connector 34 described above. The wire connection part 11d is a part that is connected to the wiring material W, and electrically connects the terminal of the wiring material W and the first connection terminal 11. The wire connection part 11d is caulked and crimped to the terminal of the wiring material W. At the terminal on the first connection terminal 11 side of the wiring material W, a sheath part W2 is stripped off and the conductor part W1 is exposed from the sheath part W2, and the wire connection part 11d is crimped to the terminal of the exposed conductor part W1.

The coupling part 11a is a part that is interposed between the connector terminal part 11c and the wire connection part 11d, and couples the connector terminal part 11c and the wire connection part 11d. In the first connection terminal 11, the connector terminal part 11c and the wire connection part 11d are electrically connected via the coupling part 11a, and the connector terminal part 11c and the conductor part W1 of the wiring material W are electrically connected and conducted via the wire connection part 11d.

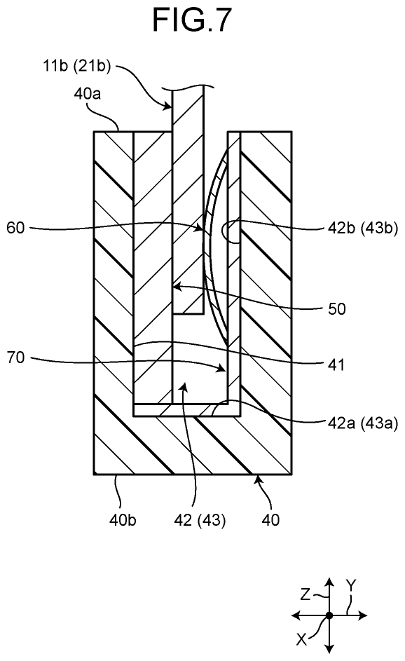

The first protrusion part 11b is a part that is inserted into the first connection port 42 of the bracket 40 (see FIG. 7), and electrically connected to the busbar 50. The first protrusion part 11b protrudes from the coupling part 11a toward the other side in the height direction Z, and penetrates through a lower wall 12d of the first casing 12 (see FIG. 4). In other words, the first protrusion part 11b is provided while protruding from the lower wall 12d of the first casing 12. In the first connection terminal 11, the first protrusion part 11b, the connector terminal part 11c, and the wire connection part 11d are electrically connected via the coupling part 11a.

FIG. 6 is a schematic sectional view of the first electronic unit 20 of the electronic component unit 1. As illustrated in FIG. 6, the first electronic unit 20 includes a second casing 22 for integrating and housing inside thereof a second connection terminal 21 as well as a substrate 23, an electronic component 24, and the like, for example. The second casing 22 is formed in a hollow box shape as a whole, and the inner space part sectioned by the outer wall of the second casing 22 functions as a housing space part 25. The second casing 22 is formed, for example, with a resin material or the like.

The second connection terminal 21 is configured including, for example, a base part 21a and a second protrusion part 21b. The second connection terminal 21 is formed with a conductive metal member as a whole. The base part 21a is a part that is connected to the substrate 23, and electrically connects the substrate 23 and the second connection terminal 21. The base part 21a extends along the axial direction X and is joined to the substrate 23 by soldering or the like at the end part of the substrate 23 side.

The second protrusion part 21b is a part that is inserted into the second connection port 43 of the bracket 40 (see FIG. 7), and electrically connected to the busbar 50. The second protrusion part 21b protrudes from the base part 21a toward the other side in the height direction z, and penetrates through a lower wall 22a of the second casing 22. In other words, the second protrusion part 21b is provided while protruding from the lower wall 22a of the second casing 22. In the second connection terminal 21, the second protrusion part 21b and the substrate 23 are electrically connected and conducted via the base part 21a.

FIG. 7 is a sectional view of the first connection port 42 (second connection port 43) of the bracket 40 of the electronic component unit 1. As illustrated in FIG. 7, the first connection port 42 is a part into which the first protrusion part 11b of the connection unit 10 is inserted, and the second connection port 43 is a part into which the second protrusion part 21b of the first electronic unit 20 is inserted. In the present embodiment, in each of the first connection port 42 and the second connection ports 43, a contact member 60 and a support member 70 are provided.

The contact member 60 is a member for energizing the first protrusion part 11b or the second protrusion part 21b to the busbar 50 side. The contact member 60 is, in the width direction Y, formed in an arc shape (arch shape) that is curved in a convex state toward the busbar 50 side from a wall face 42b or 43b of the first connection port 42 or the second connection port 43 on the opposite side from the busbar 50. In the present embodiment, the spacing between the busbar 50 and the contact member 60 in the width direction Y under a free state of the contact member 60 is set to be smaller than the thickness of the first protrusion part 11b or the second protrusion part 21b in the width direction Y.

In such a configuration, by inserting the first protrusion part 11b or the second protrusion part 21b between the contact member 60 and the busbar 50, the first protrusion part 11b or the second protrusion part 21b is elastically held between the contact member 60 and the busbar 50. Thereby, the first protrusion part 11b or the second protrusion part 21b is pressed against the busbar 50 side, which improves reliability of the electrical connection between the busbar 50 and the first protrusion part 11b or the second protrusion part 21b.

The support member 70 is a member for supporting the contact member 60. The support member 70 is formed, for example, to have an L-shaped cross-section that includes a part extending along the wall face 42b or 43b of the first connection port 42 or the second connection port 43 on the opposite side from the busbar 50, and a part extending along a bottom face 42a or 43a of the first connection port 42 or the second connection port 43. The support member 70 is formed, for example, with a conductive metal member similar to those of the contact member 60 and the busbar 50. The contact member 60 is joined to the part of the support member 70 extending along the wall face 42b or 43b by welding, caulking, or the like.

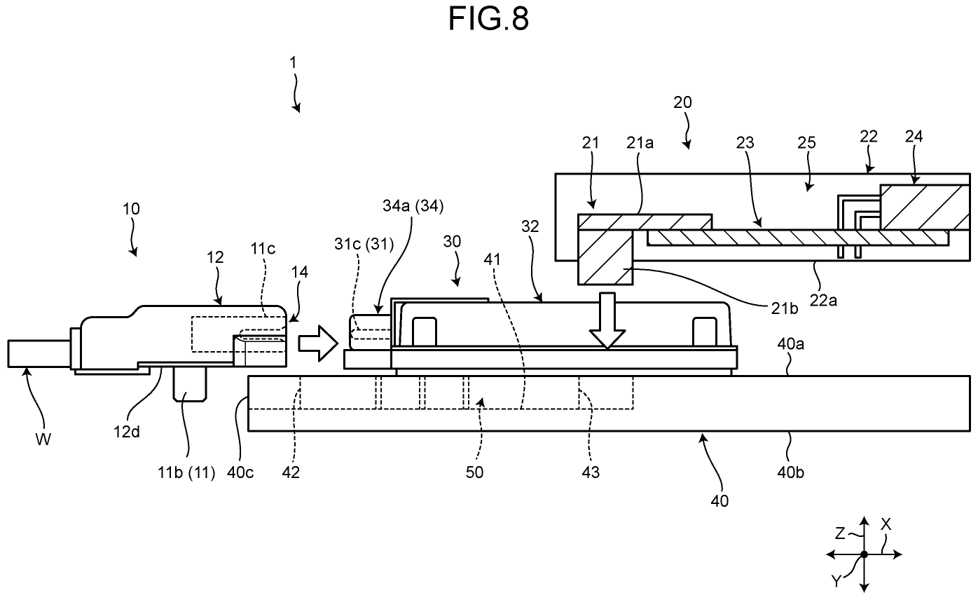

FIG. 8 is a side view (fragmentary sectional view) for describing a mounting method of the connection unit 10, the first electronic unit 20, and the second electronic unit 30 of the electronic component unit 1. As illustrated in FIG. 8, in the present embodiment, the first electronic unit 20 is mounted to the bracket 40 from the one side in the height direction Z, and the connection unit 10 is mounted from the one side in the axial direction X. Note that the second electronic unit 30 is attached in advance at a prescribed position of the bracket 40 by connectors such as bolts, for example.

Then, by inserting the second protrusion part 21b into the second connection port 43, the first electronic unit 20 is electrically connected to the busbar 50 and mounted to the bracket 40. Furthermore, by inserting the first protrusion part 11b into the first connection port 42, the connection unit 10 is electrically connected to the busbar 50 and mounted to the bracket 40, and the connection unit 10 and the first electronic unit 20 are electrically connected via the busbar 50. Moreover, at this time, by inserting the connector 14 into the mating connector 34, the connection unit 10 and the second electronic unit 30 are electrically connected, and the first electronic unit 20 and the second electronic unit 30 are electrically connected via the first connection terminal 11 and the busbar 50.

As described, according to the present embodiment, only with the work of mounting each of the connection unit 10, the first electronic unit 20, and the second electronic unit 30 to the bracket 40, mutual electrical connection thereof can be achieved as well. In that case, for example, it is possible to distribute the power supplied from the wiring material W side of the connection unit 10 to the first electronic unit 20 side and the second electronic unit 30 side in parallel via the first protrusion part 11b and the connector terminal part 11c of the first connection terminal 11.

Note that the electronic component unit 1 is not limited to this example. For example, the power supplied from the wiring material W side of the connection unit 10 may be converted by a DC/DC converter, a DC/AC inverter, or the like on the second electronic unit 30 side and distributed to the first electronic unit 20 side. Furthermore, in that case, for example, the second electronic unit 30 may be provided with a protrusion part that protrudes from the casing 32 and is electrically connected to the busbar 50 by being inserted into a connection port different from the first connection port 42 and the second connection port 43 of the bracket 40. Moreover, the second electronic unit 30 may also be connected to the connection unit 10 not through the terminal 31 of the mating connector 34, but through the busbar 50 by the protrusion part protruding from the casing 32 described above, for example, as in the case of the first electronic unit 20.

As described above, the electronic component unit 1 and the wire harness WH according to the present embodiment includes: the connection unit 10 that includes the first connection terminal 11 provided at the terminal of the wiring material W exhibiting conductivity, and the first casing 12 that houses the first connection terminal 11; the first electronic unit 20 that includes the second connection terminal 21 connected to the substrate 23, and the second casing 22 that houses the substrate 23 and the second connection terminal 21; the busbar 50 that electrically connects the first connection terminal 11 and the second connection terminal 21; and the insulating bracket 40 that includes the recessed part 41 where the busbar 50 is placed, the first connection port 42 formed at the one end part 41a of the recessed part 41, and the second connection port 43 formed at the other end part 41b of the recessed part 41. The first connection terminal 11 includes the first protrusion part 11b that protrudes from the first casing 12, and is electrically connected to the busbar 50 and mounted to the bracket 40 by being inserted into the first connection port 42. The second connection terminal 21 includes the second protrusion part 21b that protrudes from the second casing 22, and is electrically connected to the busbar 50 and mounted to the bracket 40 by being inserted into the second connection port 43.

With the electronic component unit 1 and the wire harness WH having such a configuration, each of the connection unit 10 and the first electronic unit 20 can be mounted to the bracket 40 on the vehicle side and mutual electrical connection thereof can be achieved via the busbar 50 as well by inserting the first protrusion part 11b of the first connection terminal 11 into the first connection port 42 and inserting the second protrusion part 21b of the second connection terminal 21 into the second connection port 43. As a result, the electronic component unit 1 and the wire harness WH can further enhance the workability of the connection work between the connection unit 10 and the first electronic unit 20.

Furthermore, the electronic component unit 1 and the wire harness WH according to the present embodiment include the second electronic unit 30 that is mounted to the bracket 40, and includes the mating connector 34 that is electrically and mechanically connected to the connector 14 provided in the connection unit 10. The first connection terminal 11 includes the connector terminal part 11c that is integrally formed with the first protrusion part 11b and exposed from the first casing 12, and connected to the terminal 31 of the mating connector 34. With the electronic component unit 1 and the wire harness WH having such a configuration, the connection unit 10 and the second electronic unit 30 are electrically connected, and the first electronic unit 20 and the second electronic unit 30 can be electrically connected as well via the first connection terminal 11 and the busbar 50 by connecting the connector 14 to the mating connector 34. As a result, the electronic component unit 1 and the wire harness WH can further enhance the workability of the connection work for the connection unit 10, the first electronic unit 20, and the second electronic unit 30.

Furthermore, in the electronic component unit 1 and the wire harness WH according to the present embodiment, the first connection port 42 is opened along the axial direction X of the wiring material W along which the connector 14 and the mating connector 34 are inserted and removed, and the first protrusion part 11b is inserted into the first connection port 42 in accordance with insertion of the connector 14 to the mating connector 34. With the electronic component unit 1 and the wire harness WH having such a configuration, connection work between the connector terminal part 11c of the first connection terminal 11 and the terminal 31 of the mating connector 34 and connection work between the first protrusion part 11b of the first connection terminal 11 and the busbar 50 can be performed simultaneously by inserting the connector 14 into the mating connector 34 along the axial direction X, for example. As a result, the electronic component unit 1 and the wire harness WH can still further enhance the workability of the connection work for the connection unit 10, the first electronic unit 20, and the second electronic unit 30.

Furthermore, in the electronic component unit 1 and the wire harness WH according to the present embodiment, the first connection port 42 and the second connection port 43 have the contact member 60 that energizes, toward the busbar 50 side, the first protrusion part 11b or the second protrusion part 21b inserted into the first connection port 42 and the second connection port 43. With the electronic component unit 1 and the wire harness WH having such a configuration, the first protrusion part 11b or the second protrusion part 21b is pressed against the busbar 50 side by the energizing force (elastic force) of the contact member 60 by inserting the first protrusion part 11b or the second protrusion part 21b between the contact member 60 and the busbar 50, which results in enhancing the reliability of the electrical connection between the busbar 50 and the first protrusion part 11b or the second protrusion part 21b.

### First Modification

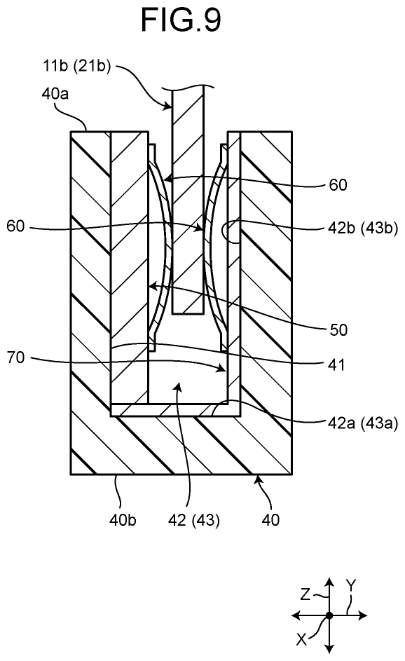

FIG. 9 is a sectional view of a first connection port 42 (second connection port 43) of a bracket 40 of an electronic component unit 1 according to a first modification. The electronic component unit 1 illustrated in FIG. 9 has the similar configuration as that of the electronic component unit 1 of the embodiment described above. Therefore, the electronic component unit 1 can acquire the similar actions and effects as those of the above-described embodiment based on the similar configuration.

However, as illustrated in FIG. 9, the first modification differs from the above-described embodiment in respect that two contact members 60 are provided in each of the first connection port 42 and the second connection port 43. In the first modification, the first protrusion part 11b or the second protrusion part 21b is inserted between the two contact members 60, and the first protrusion part 11b or the second protrusion part 21b is elastically held between the two contact members 60.

The two contact members 60 energize the first protrusion part 11b or the second protrusion part 21b toward the center side in the width direction Y. One of the contact members 60 is fixed to the busbar 50 by welding or the like, and electrically connected to the busbar 50. Furthermore, the other contact member 60 is fixed to the support member 70 by welding or the like, and electrically connected to the support member 70. The contact members 60 are formed as a curved arc shape (arch shape) in a convex state toward the center side in the width direction Y from the support member 70 and the busbar 50, respectively.

Furthermore, in the first modification, the spacing between the two contact members 60 in the width direction Y under a free state is set to be smaller than the thickness of the first protrusion part 11b or the second protrusion part 21b in the width direction Y. With such a configuration, the first protrusion part 11b or the second protrusion part 21b is elastically held between the two contact members 60 by inserting the first protrusion part 11b or the second protrusion part 21b between the two contact members 60, which results in still further enhancing the reliability of the electrical connection between the first protrusion part 11b or the second protrusion part 21b and the busbar 50.

### Second Modification

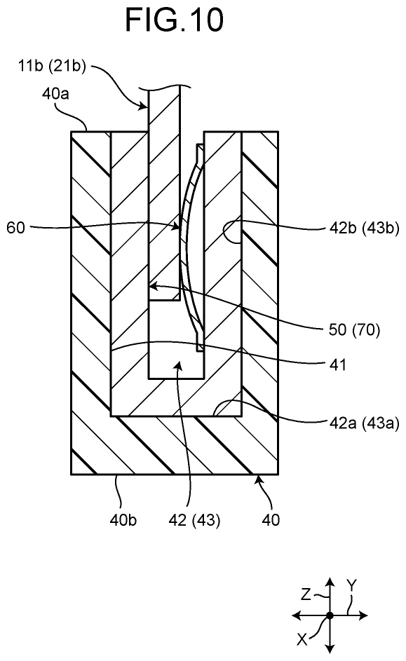

FIG. 10 is a sectional view of a first connection port 42 (second connection port 43) of a bracket 40 of an electronic component unit 1 according to a second modification. The electronic component unit 1 illustrated in FIG. 10 has the similar configuration as that of the electronic component unit 1 of the embodiment described above. Therefore, the electronic component unit 1 can acquire the similar actions and effects as those of the above-described embodiment based on the similar configuration.

However, as illustrated in FIG. 10, the second modification differs from the above-described embodiment in respect that the busbar 50 is integrally molded with the support member 70. In other words, in the second modification, the busbar 50 is formed to have a U-shaped cross-section that includes a part extending along the side face of the recessed part 41, a part extending along the bottom face of the recessed part 41 and the bottom face 42a or 43a of the first connection port 42 or the second connection port 43, and a part extending along the wall face 42b or 43b of the first connection port 42 or the second connection port 43. The contact member 60 is fixed by welding or the like to the part, which extends along the wall face 42b or 43b, of the U-shaped busbar 50 that is opened on one side in the height direction Z.

As described, in the second modification, the busbar 50 and the support member 70 are integrally molded. Therefore, it is possible to reduce the number of components and reduce the time and effort as well as the cost required to manufacture the electronic component unit 1. While the contact member 60 is configured as a separate component from the support member 70 and the busbar 50 in the second modification, the first modification, and the embodiment described above, the contact member 60 may be integrally molded with the support member 70 and the busbar 50.

With the electronic component unit and the wire harness according to the present invention, each of the connection unit and the first electronic unit can be mounted to the bracket and mutual electrical connection thereof can be achieved via the busbar as well by inserting the first protrusion part of the first connection terminal into the first connection port and inserting the second protrusion part of the second connection terminal into the second connection port. As a result, the electronic component unit and the wire harness can achieve an effect of further enhancing the workability of the connection work between the connection unit and the first electronic unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic component unit, comprising:
a connection unit that includes a first connection terminal provided at a terminal of a wiring material exhibiting conductivity, and a first casing that houses the first connection terminal;
a first electronic unit that includes a second connection terminal connected to a substrate, and a second casing that houses the substrate and the second connection terminal;
a busbar that electrically connects the first connection terminal and the second connection terminal; and
an insulating bracket that includes a recessed part where the busbar is placed, a first connection port formed at one end part of the recessed part, and a second connection port formed at another end part of the recessed part, wherein
the first connection terminal includes a first protrusion part that protrudes from the first casing, the first protrusion part being electrically connected to the busbar and mounted to the bracket by being inserted into the first connection port, and
the second connection terminal includes a second protrusion part that protrudes from the second casing, the second protrusion part being electrically connected to the busbar and mounted to the bracket by being inserted into the second connection port.

2. The electronic component unit according to claim 1, further comprising:
a second electronic unit that is mounted to the bracket, the second electronic unit including a mating connector that is electrically and mechanically connected to a connector provided in the connection unit, wherein
the first connection terminal includes a connector terminal part that is integrally formed with the first protrusion part and exposed from the first casing, and connected to a terminal of the mating connector.

3. The electronic component unit according to claim 2, wherein
the first connection port is opened along an axial direction of the wiring material along which the connector and the mating connector are inserted and removed, and
the first protrusion part is inserted into the first connection port in accordance with insertion of the connector to the mating connector.

4. The electronic component unit according to claim 1, wherein
at least one of the first connection port and the second connection port includes a contact member that energizes, toward the busbar side, the first protrusion part or the second protrusion part inserted into the one of the first connection port and the second connection port.

5. The electronic component unit according to claim 2, wherein
at least one of the first connection port and the second connection port includes a contact member that energizes, toward the busbar side, the first protrusion part or the second protrusion part inserted into the one of the first connection port and the second connection port.

6. The electronic component unit according to claim 4, wherein
at least one of the first connection port and the second connection port includes a support member that extends along a wall face of the one of the first connection port and the second connection port, and supports the contact member, and
the busbar is integrally molded with the support member.

7. The electronic component unit according to claim 5, wherein
at least one of the first connection port and the second connection port includes a support member that extends along a wall face of the one of the first connection port and the second connection port, and supports the contact member, and
the busbar is integrally molded with the support member.

8. A wire harness comprising:
a wiring material exhibiting conductivity;
a connection unit that includes a first connection terminal provided at a terminal of the wiring material, and a first casing that houses the first connection terminal;
a first electronic unit that includes a second connection terminal connected to a substrate, and a second casing that houses the substrate and the second connection terminal;
a busbar that electrically connects the first connection terminal and the second connection terminal; and
an insulating bracket that includes a recessed part where the busbar is placed, a first connection port formed at one end part of the recessed part, and a second connection port formed at another end part of the recessed part, wherein
the first connection terminal includes a first protrusion part that protrudes from the first casing, the first protrusion part being electrically connected to the busbar and mounted to the bracket by being inserted into the first connection port, and
the second connection terminal includes a second protrusion part that protrudes from the second casing, the second protrusion part being electrically connected to the busbar and mounted to the bracket by being inserted into the second connection port.
